(19) United States
(12) Patent Application Publication
(10) Pub. No.: US 2002/0072951 A1
(43) Pub. Date: Jun. 13, 2002

(54) MARKETING SUPPORT DATABASE MANAGEMENT METHOD, SYSTEM AND PROGRAM PRODUCT

(76) Inventors: MICHAEL LEE, FREMONT, CA (US); ASHLEY STIRRUP, SEATTLE, WA (US)

Correspondence Address: Cooley Godward LLP, Patent Group, One Freedom Square - Reston Town Center, 11951 Freedom Drive, Reston, VA, 20190-5601, US

(21) Appl. No.: 09/261,773

(22) Filed: Mar. 3, 1999

(51) Int. Cl. G06F 17/60

(52) U.S. Cl. 705/10

(57) ABSTRACT

A method of an a program product for collecting, analyzing, and presenting data by extracting input data from an input database. The input data is then transformed into a suitable schema for subsequent analysis, followed by subsequent analysis of the extracted and transformed data, and presentation of the analyzed, transformed, extracted data.

### FIELD OF THE INVENTION

Our invention relates to database management and usage, and especially collecting, analyzing, and presenting data by extracting input data from an input database. The input data is then transformed into a suitable schema for subsequent analysis, followed by subsequent analysis of the extracted and transformed data, and presentation of the analyzed, transformed, extracted data.

### BACKGROUND OF THE INVENTION

As enterprises grow larger, and more complex, their supply and buying needs, as a customer, grow even more complex. For example, the buying history of one customer with one vendor become disparate and complex with special orders, special products, limited production runs, special financial terms and conditions, and special service and support programs, terms, and conditions. A representative servicing one line at a given customer may have need for information about other lines sold to that customer, or about similar lines sold to a different customer.

Thus, a clear need exists for rapid collection, analysis, and presentation of mission critical data located across several enterprise-wide databases. A further need exists for rapid extraction of input data from one or more input databases, especially with transformation into a suitable schema, that is, suitably specialized, tailored, and engineered schema, for subsequent analysis. A further need exists beyond analysis of the extracted and transformed data, for presentation of the analyzed, transformed, extracted data in a useful and understandable manner.

### OBJECTS OF THE INVENTION

It is an object of the invention to provide rapid collection, analysis, and presentation of mission critical data located across several enterprise-wide databases.

It is a further object of the invention to provide rapid extraction of input data from one or more input databases, especially with transformation into a suitable schema, that is, suitably specialized, tailored, and engineered schema, for subsequent analysis.

It is still a further object of the invention to provide presentation of the analyzed, transformed, extracted data in a useful and understandable manner extending beyond analysis of the extracted and transformed data.

### SUMMARY OF THE INVENTION

According to the invention described herein, these objects are attained by the systems, method, and program product of the invention. One preferred embodiment of the invention is a method of collecting, analyzing, and presenting data. This method includes the steps of extracting input data from an input database. Next, the extracted data is transformed into a suitable schema, as a star schema, for subsequent analysis. In the next step the extracted and transformed data is analyzed and presented.

The input data can be one of more of online transaction processing data, external data, and legacy data. The data analysis may be carried out through one or more of queries, and ad-hoc queries on the extracted and transformed data and narratives and briefings from the data. The data may be analyzed by analyzing specific fields.The analysis results may be stored for further use, for example, for use before performing a new analysis.

The extracted and transformed data may be analyzed using stored queries and outputs.

According to a preferred exemplification of the invention described herein, such data as sales campaign data, wherein said input data includes customer, product, sales, pipeline, competitor, channel, service, and campaign data may be used and the outputs can include charts, tables, and summary text. The specific data is selected from opportunities, quotes, service requests, customer profiles, satisfaction surveys, prospects, and customers.

The data may be continuously updated or updated upon reloading.

Another exemplification of the invention described herein is a program product, that is, an article of manufacture comprising a computer usable medium having computer readable program code embodied therein. This computer readable program code causes collection, analysis, and presentation of data. Specifically, the computer readable program code includes code segments causing a computer to effect extraction of input data from an input data base, transforming the extracted data into a suitable schema for subsequent analysis; analysis of the extracted and transformed data; and presentation of the extracted, analyzed, transformed data.

The program product also program code for causing a computer to effect queries and ad hoc queries on the extracted and transformed data and on narratives and briefings from the data, as well analyzing the extracted and transformed data by performing one or more of queries, and ad-hoc queries on the extracted and transformed data and narratives and briefings from the data, and by specific fields of the data.

The program product may also include program code for causing storing the analysis results, for example, to avoid performing an unneeded new analysis. The program product may also use stored queries and outputs to perform analyses.

The program product may include program code for causing collecting and generating sales campaign data, wherein said input data includes customer, product, sales, pipeline, competitor, channel, service, and campaign data, where the outputs may include charts, tables, and summary text.

In a preferred exemplification the program product contains program code for causing collecting and generating sales campaign data, and the schema are chosen from the group consisting of opportunities, quotes, service requests, customer profiles, satisfaction surveys, prospects, and customers.

The program product also contains program code to effect updating, for example, program code for continuously updating of the input data, or for updating the input data upon reloading.

A still further exemplification of our invention is program storage device that is readable by a machine, and that tangibly embodies a program of instructions executable by a machine to perform method steps for carrying out the steps of extracting input data from an input database; transforming the extracted data into a suitable schema for subsequent analysis; analyzing the extracted and transformed data; and presenting the analyzed, transformed, extracted data.

### THE FIGURES

The method and program product of our invention may be understood by reference to the figures appended hereto.

FIG. 1, including FIG. 1A and FIG. 1B, shows a screen print of the campaign analysis and campaign briefing applications.

FIG. 2 shows a screen print of the data navigation tool.

FIG. 3 shows a screen print of the sales pipeline application.

### DETAILED DESCRIPTION OF THE INVENTION

Data Mart

The invention described herein is a data mart and data mart builder for collecting, analyzing, and presenting data, by extracting input data from an input database. Next, the extracted data is transformed into a suitable schema, as a star schema, for subsequent analysis, and analyzing and presenting the data. The data mart builder is a set of components which together automatically extract, transform, and populate the data mart. The data mart builder executes on a server. Using pre-configured procedures, data is extracted at regular time intervals from the OLTP (On Line Transaction Processing) database used by host programs, such as Siebel Sales Enterprise and Siebel Service Enterprise into the data mart. In order to optimize decision support performance, the OLTP (On Line Transaction Processing) data is transformed into star schemas for the target RDBMS (Relational Database Management System). The data mart builder is a general-purpose facility used to populate the data mart based on data generated within all of the server based applications, including, for example, Siebel Enterprise Applications, as well as from other sources such as syndicated data feeds and other enterprise or legacy applications. The data mart is a separate relational database that takes advantage of ROLAP (Relational Online Analytical Processing) technology to ensure fast and efficient analysis.

The use of a star schema allows the method and program product of the invention to process large quantities of data and deliver sophisticated analyses, and to store query sets for subsequent use.

Marketing Analysis

The method and program product of the disclosed invention can be used as the basis for a market analysis application, such as Siebel Market Analysis. Siebel Marketing Analysis provides sophisticated OLAP analysis within the standard web browser user interface. This user interface allows marketing professionals to easily navigate to the type of analysis they need and to then drill into each analysis to understand underlying trends. Using tools such as Siebel Marketing Analysis, users can easily query their data for instant information on customer, product and competitive trends in their markets. Marketing Analysis enables an organization to rapidly convert customer and market data into knowledge that powers effective sales and marketing strategies. Data gathered from the execution of marketing and sales campaigns, from requests for customer service, and from external sources is transformed by Siebel Marketing Analysis and stored in a high performance data mart.

Analyses and Briefings

The client input/output and presentation application, such as Siebel Marketing Analysis, allows executives, managers and marketing analysts to easily view, analyze, and present the data in a variety of ways to uncover trends and better respond to changes in customer requirements or market conditions. Pre-built analyses allow managers and professionals to answer timely questions, such as “Which products are exceeding projections in the current period?” Or, “How effective is the campaign launched last quarter?” Or, “Is the quality of my customer service affecting follow-on sales?” These comprehensive analyses address these questions and many more.

Briefings capability provides insightful summaries on specific topics such as products, customers, and campaigns. Pre-built marketing analyses may be organized into the following eight categories: Customer, Product, Campaign, Sales, Pipeline, Competitor, Channel and Service which comprehensively monitor and measure the performance of the sales, service, call center and marketing functions.

Customer analyses provide comprehensive analysis of the behavior and market trends within you customer base. These analyses provide important insight into top customers and customer segments and their purchasing behavior. Analysis of customer buying history enables marketing analysts to determine the value of customers in terms of revenue, profitability and purchasing frequency.

Product analyses enables users to identify top selling products, track trends in sales over time and measure the profitability of products and product lines. Product analyses will provide great value to managers throughout your company in finance, operations, marketing, sales or customer service who are concerned with changes in customer demand and the most up to date information on forecasted future product purchases.

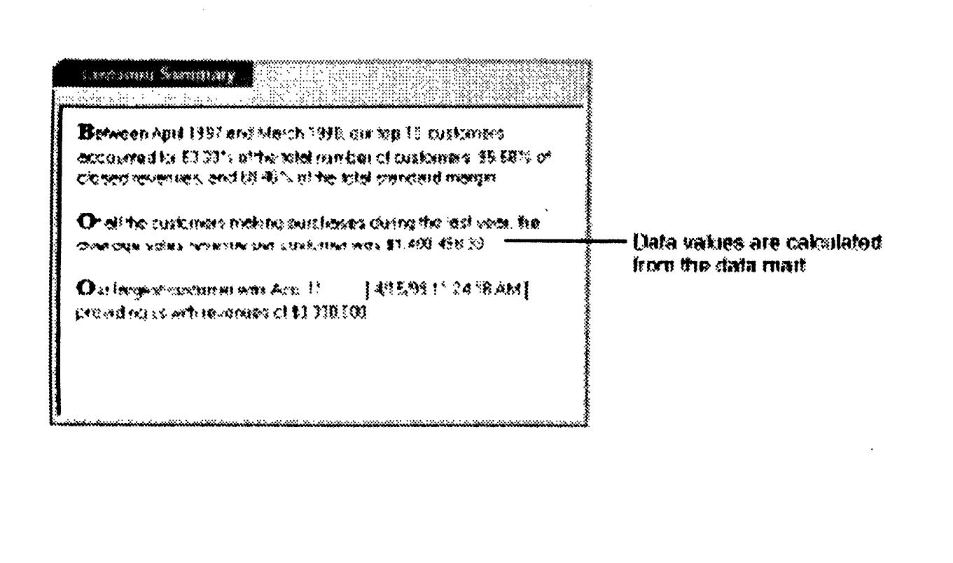

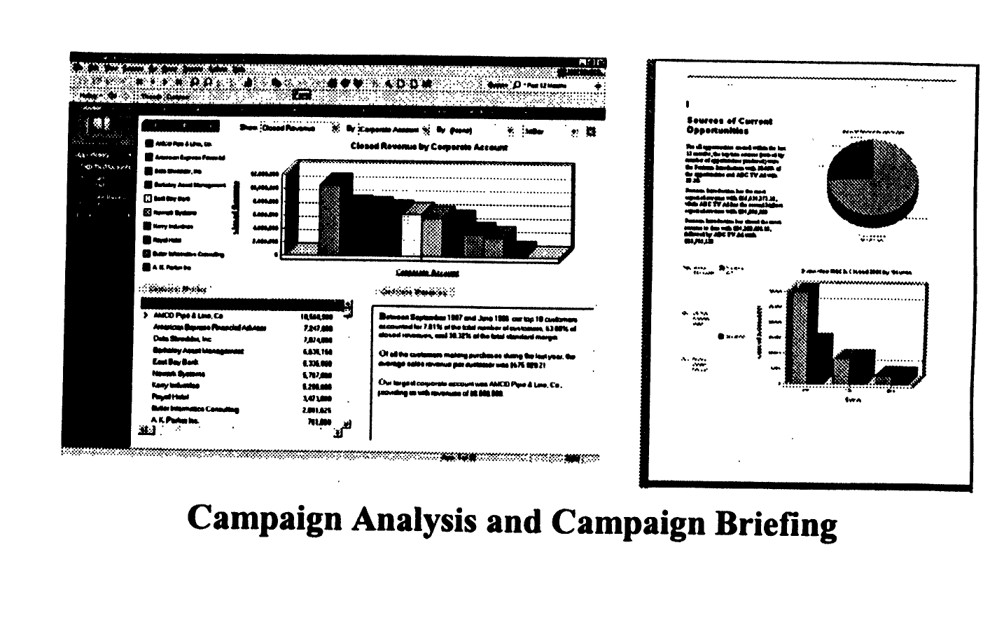

Campaign analyses has an output screen as shown in FIG. 1, which shows both a Campaign Analysis Screen FIG. 1A and a Campaign Briefing Screen, FIG. 2B. Campaign Analysis allows marketing managers to perform analysis of revenues, returns on investment and how campaign leads have moved through the sales pipeline. Campaign analyses provides comprehensive insight into how and where leads are generated, the most effective sources of leads and how successful marketing campaigns lead to increased sales.

Sales analyses provide a high level view of your company's performance. Included are analyses of the overall trends in sales, expected sales and sales lost to competitors. This enables managers to measure how well the company is performing and how well the company has been projecting performance.

Pipeline analyses provide data about the health of the current pipeline, including analysis of revenue in the pipeline, trends in the average sales cycle and which opportunities are taking the longest to close. These analyses enable a marketing manager to track how well they are feeding their pipeline, how long their products are taking to sell and where in the sales process they can add the most value.

Channel analyses include information on the performance of each channel of distribution, the profitability of each channel, their top selling products and most important customers. This information is vital for determining where a marketing manager should be focusing their promotional activity and how they can improve the performance of their channel partners.

Competitor analysis provides information on which competitors are faced most often, how well your company competes against each of these competitors, and analyzes why deals were won or lost. Such analysis enables a marketing manager to determine who they need to focus their marketing efforts on and where they need to improve their positioning.

Service analysis provides analysis of which products are generating the most service requests, how long service requests take to close and how satisfied customers are with the products they purchase and the support they receive on them. Customer loyalty is a critical success factor and these analyses tell a marketing manager how and where they need improve the products they are selling and the expectations they are setting.

Measuring customer profitability and lifetime value is just one example of the applicability of the method and program product of the invention. Understanding the value of customers and customer segments is critical to the success of marketing strategies. Armed with this information marketers can tailor their campaign offers to better target their most valuable customers. provides a series of analyses that enable marketing managers to determine which customers and customer segments are buying which products and the profitability of those products and customers. Marketing analysts can also review the trends in average prices, costs, and profitability over time by product, customer or customer segment. The Customer Briefing is excellent way to obtain a comprehensive update on customers, their buying patterns, their satisfaction with products and even the frequency in which they consider buying from specific vendors.

Data Navigation

Data Navigation is illustrated in FIG. 2 which shows charts, tables, and summary text. The Siebel Marketing Enterprise application, using the method and program product disclosed herein, leverages the same intuitive, web browser interface that is standard with all applications. This interface makes navigating to the right analysis quick, and easy.

Siebel Marketing Enterprise or other software products using the method and program product of the disclosed invention provide pre-built Analyses that managers and professionals use to answer timely questions, such as “Which products are exceeding their forecast in the current period?” Or, “How effective is the campaign launched last quarter?” Or, “Is the quality of my customer service affecting follow-on sales?” The pre-packaged analyses address these questions and many more.

The page tabs logically group analyses within eight business categories:

Customer

Competitor

Product

Channel

Sales

Service

Pipeline

Campaigns

Each screen presents data in three formats:

Charts Provide visual representation of the data.

Tables Provide the underlying numbers behind the charts and details.

Summary TextTells the story behind the data and makes key observations about the information provided.

Marketing Enterprise efficiently and comprehensively monitors and measures the performance of the sales, service, call center and marketing functions within your organization.

Slice & Dice

Marketing Analysis allows executives, managers and sales professionals to view, analyze, and present data. Pre-built analyses enable users to quickly identify trends. Managers can drill into these trends, with the point-and-click user interface, to identify root causes, underlying market changes. The ability to quickly understand market trends means that organizations are better prepared to respond to changes in their customer's requirements or market conditions.

When you select a view, MARKETING ENTERPRISE PRODUCT dynamically calculates and inserts data values from the data mart into a concise paragraph called a narrative.

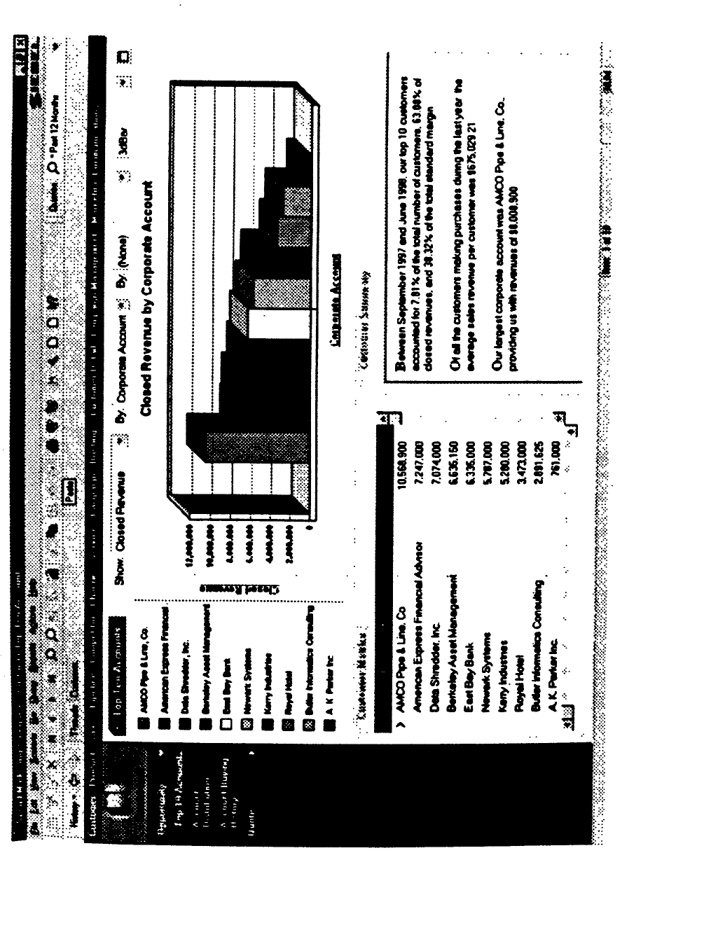

Narratives use predetermined text that highlight the most important trends analyzed within the view. Summaries are provided with most charts, except those created by drilling down into aggregate data. Summaries do not change as you drill down into a chart or table. FIG. 3 below shows a sample summary from the Sales Pipeline by Sales Stage screen.

The Shrink Wrapped data mart

The data mart of our invention supports revenues in multiple currencies and provides pre-calculated and pre-aggregated data that can be queried in a very efficient fashion even when vast amounts of data are involved. DBMS direct loading techniques combined with parallel processing and a scalable architecture provide extremely efficient data extraction, transformation and loading capabilities.

According to our invention, data hierarchies are de-normalized so that aggregations can efficiently be performed at any level of a hierarchy. Data inconsistencies in the transactional system are handled (and later reported) so that no additional work needs to be done before a fully functional data mart can be built.

Detailed Diagnostics and Exception Reports are hosted in a user interface and provide the platform from where gaps and inconsistencies in the transactional system can be analyzed and rectified for better data analysis.

Given an existing transactional DBMS, the data mart Builder of our invention builds a fully functional data mart with six key star schemas immediately after installation. These are centered on Opportunities, Quotes, Service Requests, Customer Profiles, Satisfaction Surveys and Customers/Prospects. This provides the ability to rapidly begin Decision Support analysis on key elements of an existing database.

Pre-configured procedures, that are customizable and extendable, are used to extract, transform and load the transactional data to the analytical database.

The Star Schema are extendable to include data from a variety of data sources, as the Web, vendored sources, subscription sources, and the like, as well as additional elements from internal sources.

Analysis Proxy Server

The Analysis Proxy Server is a component integral to the Marketing Enterprise. In conjunction with Analysis Query Server, Analysis Proxy Server provides querying and caching service for all Marketing Enterprise clients that need to retrieve and analyze data in a “data mart”.

An OLTP (online transaction processing) database contains operational data that are continuously updated. A data mart, on the other hand, contains a snapshot of the operational data at a given time frame and aggregate information of this snapshot. Unlike an OLTP database, where the same query can return vastly different result from minute to minute, the data in a data mart remains unchanged until they are reloaded. So long as the data are not reloaded in the data mart, a query returns the same result every time it is executed. Analysis Proxy Server exploits this characteristic and store query results on a disk cache to improve performance.

When a client request an OLAP (online analysis processor) query against the data mart, it submits the query to Analysis Proxy Server. Analysis Proxy Server examines its disk cache for result previously obtained from the same query. If one is found, it will simply return that result without executing the query again. If none is found, it executes the query (through Analysis Query Server) against the data mart, stores the result in its disk cache, and returns the result to the client.

Because of their intensive analytical nature, OLAP queries against a data mart can take a very long time to execute. Some of them can take hours before any result is returned. Without any kind of caching, such queries cause lengthy delay on every client that requests them. With the introduction of Analysis Proxy Server, this delay is limited to the first client that requests them, hence improving response time on all the other clients. This marks a significant performance improvement on marketing automation applications such as Siebel Marketing Enterprise.

Cache Generator

The Marketing Enterprise Cache Generator is an application that exercises a Marketing Enterprise Client, systematically executing every possible combination of query accessible to the user through the user interface. The marketing enterprise cache generator communicates with the marketing enterprise client through a published application programming interface. The intention of this application is to pre-populate the marketing enterprise analysis proxy server's cache so that actual users do not experience lengthy delays when using the other marketing enterprise application.

Because of their intensive analytical nature, OLAP queries against a data mart can take a very long time to execute. Some of them can take hours before any result is returned. With the introduction of marketing enterprise analysis proxy server, this delay is limited to the first client that requests them, hence improving response time on all the other clients. By running the marketing enterprise cache generator after the mart is built, event the first user would not experience any response delay. This further improves the marketing enterprise OLAP analysis performance.

Marketing Enterprise Campaign Generation

The above features are integrated into several possible output tools. One such tool is the Marketing Enterprise Campaign Generation tool. This is because the Marketing Enterprise not only provides extensive configurable and extendable OLAP decision support analysis capabilities, it also provides a one-button campaign generation feature. Marketing enterprise allows the marketing managers to use marketing enterprise pre-configured views or to run ad-hoc queries to analyze the customer profile or other marketing analysis. Once users are satisfied with the analysis, they can press the Campaign generation button to automatically create a new campaign or picking an existing campaign. marketing enterprise will automatically associate all the contacts and prospects based on the current OLAP analysis query to the campaign. The marketing managers can then send the newly created campaigns to the external channel or the call center to execute the campaigns.

The one-button marketing enterprise Campaign Generation feature allows the marketing managers to easily create segmented list for new and existing campaigns based on their pre-configured or ad hoc queries. This features drastically reduces the time they spend on segmenting their target markets and create campaigns for these targeted markets.

While the invention has been described with respect to certain preferred embodiments and exemplifications, it is not intended to limit the scope of the invention thereby, but solely by the claims appended hereto.

We claim:

1. A method of collecting, analyzing, and presenting data comprising the steps of:
a. extracting input data from an input database;
b. transforming the extracted data into a suitable schema for subsequent analysis;
c. analyzing the extracted and transformed data; and
d. presenting the analyzed, transformed, extracted data.

2. The method of claim 1 wherein the input data includes one of more of online transaction processing data, external data, and legacy data.

3. The method of claim 1 comprising analyzing the extracted and transformed data by performing one or more of queries, and ad-hoc queries on the extracted and transformed data and narratives and briefings from the data.

4. The method of claim 3 comprising analyzing the data by specific fields thereof.

5. The method of claim 3 comprising storing analysis results.

6. The method of claim 5 comprising searching stored analysis results before performing a new analysis.

7. The method of claim 3 comprising analyzing the extracted and transformed data using stored queries and outputs.

8. The method of claim 7 comprising collecting and generating sales campaign data, wherein said input data includes customer, product, sales, pipeline, competitor, channel, service, and campaign data, and said outputs include charts, tables, and summary text.

9. The method of claim 1 wherein said schema is a star schema.

10. The method of claim 9 comprising collecting and generating sales campaign data, and said schema are chosen from the group consisting of opportunities, quotes, service requests, customer profiles, satisfaction surveys, prospects, and customers.

11. The method of claim 1 comprising continuously updating the input data.

12. The method of claim 1 comprising updating the input data upon reloading.

13. An article of manufacture comprising a computer usable medium having computer readable program code embodied therein for causing collection, analysis, and presentation of data, the computer readable program in said article of manufacture comprising:
computer readable program code for causing a computer to effect extraction of input data from an input data base;
computer readable program code for causing a computer to effect transforming the extracted data into a suitable schema for subsequent analysis;
computer readable program code for causing a computer to effect analysis of the extracted and transformed data; and
computer readable program code for causing a computer to effect presentation of the extracted, analyzed, transformed data.

14. The program product of claim 13 further comprising program code for causing a computer to effect queries and ad hoc queries on the extracted and transformed data and on narratives and briefings from the data.

15. The program product of claim 13 further comprising program code for causing analyzing the extracted and transformed data by performing one or more of queries, and ad-hoc queries on the extracted and transformed data and narratives and briefings from the data.

16. The program product of claim 14 further comprising program code for causing analyzing the data by specific fields thereof.

17. The program product of claim 14 further comprising program code for causing storing analysis results.

18. The program product of claim 17 further comprising program code for causing searching of the stored analysis results before performing a new analysis.

19. The program product of claim 14 further comprising program code for causing analysis of the extracted and transformed data using stored queries and outputs.

20. The program product of claim 19 further comprising program code for causing collecting and generating sales campaign data, wherein said input data includes customer, product, sales, pipeline, competitor, channel, service, and campaign data, and said outputs include charts, tables, and summary text.

20. The program product of claim 13 wherein said schema is a star schema.

21. The program product of claim 20 further comprising program code for causing collecting and generating sales campaign data, and said schema are chosen from the group consisting of opportunities, quotes, service requests, customer profiles, satisfaction surveys, prospects, and customers.

22. The program product of claim 13 further comprising program code for causing continuously updating of the input data.

23. The program product of claim 13 further comprising program code for causing updating the input data upon reloading.

24. A program storage device readable by a machine, tangibly embodying a program of instructions executable by a machine to perform method steps for:
extracting input data from an input database;
transforming the extracted data into a suitable schema for subsequent analysis;
analyzing the extracted and transformed data; and
presenting the analyzed, transformed, extracted data.
